(19) United States
(12) Patent Application Publication
(10) Pub. No.: US 2008/0116254 A1
(43) Pub. Date: May 22, 2008

(54) Wireless diagnostic download

(75) Inventor: David J. Sleeman, Broughty Ferry (GB)

Correspondence Address: MICHAEL CHAN;NCR CORPORATION, 1700 SOUTH PATTERSON BLVD, DAYTON, OH, 45479-0001, US

(73) Assignee: NCR Corporation

(21) Appl. No.: 11/585,643

(22) Filed: Oct. 24, 2006

(51) Int. Cl. G06F 17/00; G07F 19/00

(52) U.S. Cl. 235/375; 235/379

(57) ABSTRACT

A system and method of managing and replenishing Self-Service Terminals (SSTs). A wireless link is established between a secure vehicle and an SST in order for the SST to transmit status information to the secure vehicle to enable a decision to be taken whether to proceed with replenishment of the SST from the secure vehicle. Systems and methods are also provided for the transfer of status logs from SSTs to secure vehicles for further transmission to technicians for repair and/or maintenance of the SST.

### TECHNICAL FIELD

The present invention relates to a method of communicating between an Automated Teller Machine (ATM) and a mobile vehicle. It is particularly related to, but in no way limited to, the communication of status information from the ATM to the mobile vehicle during a delivery to the ATM.

### BACKGROUND

Deliveries of money are made to Automated Teller Machines (ATMs) on a regular basis to ensure that each ATM has, at all times, a sufficient stock of money to supply users of the terminal. Due to the popularity of ATMs, large amounts of money must be delivered on a regular basis. Money is transported to a location close to an ATM within a secure vehicle, and transferred from that vehicle to the ATM by security personnel. During the transfer of the money from the secure vehicle to the ATM, the security personnel are exposed to the risk of attack from persons wishing to steal the money.

Deliveries are typically made to ATMs according to a routine schedule, defined according to the typical usage of each ATM. However, replenishment of a given ATM may not be possible according to the standard schedule. For example, a machine may have a fault which prevents its replenishment. ATMs communicate status information to a central system on a regular basis, and that information may be utilized to adapt delivery schedules such that visits are not made to replenish faulty ATMs. However, it is possible that a fault will develop at such a time that it is not possible to notify security personnel due to be visiting the ATM to replenish it that it is faulty. In that case, the security personnel will not discover that they cannot replenish the ATM until they have arrived at the ATM and viewed status indicates on the ATM. The security personnel have therefore unnecessarily left the secure vehicle and been exposed to the risk of attack.

A variety of logs are stored by an ATM during its operation, but due to bandwidth limitations it is not possible to transmit all of those logs via the ATM's regular status communications to a central system and only a selection of the data is routinely submitted. Detailed data relating to the operation of the ATM, which may be required by a technician to repair an ATM, is therefore only available by visiting the ATM and accessing the data. That delay in obtaining information may delay repair of the ATM.

The current invention seeks to provide a system and method which reduce the unnecessary exposure of security personnel to the risk of attack. The invention also seeks to provide an improved system and method of fault reporting and fault data collection.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to a first aspect of the present invention there is provided a method of replenishing a Self-Service Terminal (SST), comprising the steps of: establishing a wireless communications link between an SST and a vehicle, the vehicle receiving status information with regard to the state of the SST via the wireless communications link, and performing an action dependent upon the status information received by the vehicle.

According to a second aspect of the present invention, there is provided a Self-Service Terminal (SST) management system, comprising: a mobile wireless communications device, configured to establish a wireless communications link with an SST which is temporarily within range of that mobile wireless communications device, and a processing system connected to the mobile wireless communications device, such that the processing system can communicate with the SST via the wireless communications link, wherein the processing system is configured to receive status information from the SST via the wireless communications link which is indicative of the ability of the SST to function at that time.

According to a third aspect of the present invention, there is provided a Self-Service Terminal (SST), comprising: a fixed wireless communications device, configured to establish a wireless communications link with a mobile wireless communications device temporarily brought within the range of the fixed wireless communications device, and a processing system connected to the fixed wireless communications device, the processing system being configured to transmit status information via the wireless communications link.

The method of replenishing a Self-Service Terminal (SST) may also comprise the step of displaying information with regard to the state of the SST in the vehicle.

The action performed may be the provision of an indication to security personnel to proceed with replenishment of the SST. Alternatively, the action performed may be the provision of an indication to security personnel not to proceed with replenishment of the SST.

The method of replenishing a Self-Service Terminal (SST) may also comprise the step of controlling the transfer of an item out of the secure vehicle dependent upon the status information received by the vehicle.

The method of replenishing a Self-Service Terminal (SST) may further comprise the step of the vehicle receiving and storing status information from the SST.

The mobile wireless communications device and processing system may be located in a secure vehicle.

The secure vehicle may further comprise a transfer device for transferring items into and out of the secure vehicle. The transfer device may be configured to be controlled dependent upon status information received from the SST.

The secure vehicle may further comprise a display device for displaying status information received from the SST.

The Self-Service Terminal (SST) management system may further comprise a removable data storage device connected to the processing system and configured to store information received via the wireless communications link from the SST.

The Self-Service Terminal (SST) management system may further comprise a fixed wireless communications device for connection to an SST.

The fixed wireless communications device may be configured to transmit status information to a mobile wireless communications device temporarily brought within range of the fixed wireless communications device.

The Self-Service Terminal (SST) may be configured to transmit logs of status information from the SST to the mobile wireless communications device via the wireless communications link.

The method may be performed by firmware or software in machine readable form on a storage medium.

This acknowledges that firmware and software can be valuable, separately tradable commodities. It is intended to encompass software, which runs on or controls “dumb” or standard hardware, to carry out the desired functions. For similar reasons, it is also intended to encompass software which “describes” or defines the configuration of hardware, such as HDL (hardware description language) software, as is used for designing silicon chips, or for configuring universal programmable chips, to carry out desired functions.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 is a schematic diagram of an ATM and a secure vehicle; and

FIG. 2 is a flow diagram of a method for the replenishment of an ATM.

### DETAILED DESCRIPTION

Embodiments of the present invention are described below by way of example only. These examples represent the best ways of putting the invention into practice that are currently known to the Applicant although they are not the only ways in which this could be achieved.

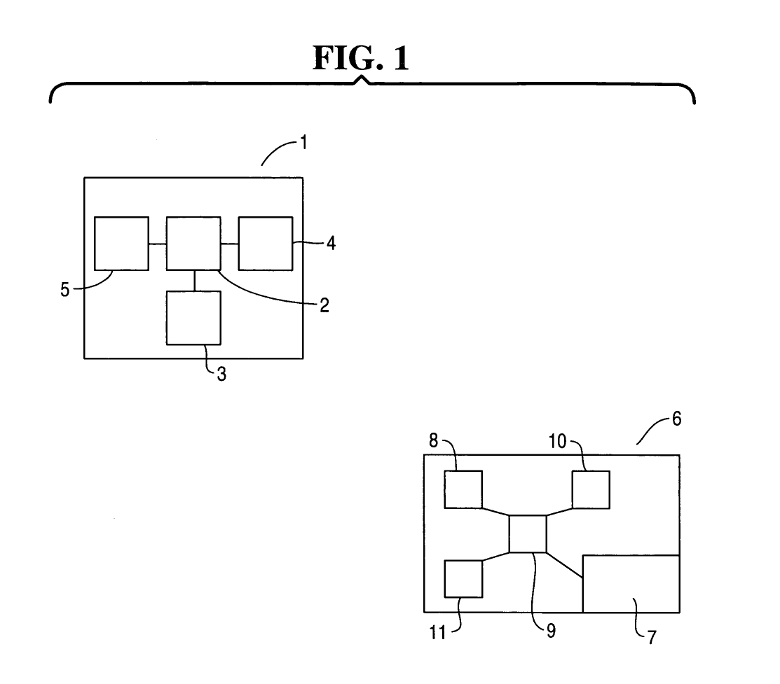

FIG. 1 shows an ATM 1 having a processing system 2 and memory 3. The processing system 2, amongst other functions, controls the operation of the ATM 1 and monitors and records its status. The status information may be recorded in memory 10. The ATM 1 may have a display panel 4 visible outside of the ATM safe for the display of status information from the processing system 2. For example, information relating to fault conditions may be displayed. In conventional methods of ATM replenishment, the display panel 4 would be viewed by security personnel arriving at the ATM with a cash cassette, prior to opening the ATM safe cassette. Should the display panel 4 indicate that replenishment is not possible due to a fault condition, the security personnel would return to the secure vehicle with the cash cassette. The security personnel have therefore been unnecessarily exposed to the risk of attack.

The ATM 1 has a wireless communications device 5 connected to the ATM's processing system 2. The wireless communications device 5 and processing system 2 are configured such that status information can be communicated via a wireless communications link established between the device 5 and an external wireless communications device.

A secure vehicle 6 for use in the delivery of cash to ATMs is shown in FIG. 1 and is equipped with a transfer device 7 such that cash cassettes can be transferred from the secure interior of the vehicle to security personnel outside of the vehicle for transport to the ATM. The vehicle also has a wireless communications device 8 for establishing a wireless communications link with an ATM 1. Processing system 9 is connected to wireless communications device 8 and allows information about ATM 1 to be processed. Information relating to the status of the ATM 1 may be displayed on a display 10 inside the secure vehicle.

When the vehicle 6 arrives at an ATM 1 to replenish the ATM 1, a wireless communications link is established between the vehicle 6 and the ATM 1, via the wireless communications devices 5 and 8. The processing system 9 requests information from the ATM 1 with regard to the status of the ATM 1, and in particular, whether the ATM 1 can accept replenishment. That information is displayed on the display 10 in the vehicle in order for security personnel to determine whether to proceed with the replenishment. Should the displayed information indicate that replenishment is not possible, security personnel can remain within the secure vehicle and are not, therefore, unnecessarily exposed to the risk of attack.

Transfer device 7 is an automated device which allows the transfer of items into, and out of, the secure vehicle 6 and is controlled by processing system 9. When transferring a cash cassette out of the secure vehicle to security personnel, the status of the ATM 1 is checked to ensure that the cash cassette about to be passed out can be accepted by the ATM 1. Should the ATM 1 have a fault that would prevent a cash cassette being loaded, no cassettes are transferred out of the secure vehicle. Cash cassettes are therefore only placed in the more risky environment outside of the secure vehicle 6 when they may be loaded into an ATM 1.

Replenishment of an ATM 1 may require the transfer of more than one cash cassette and the security personnel may therefore make multiple trips between the secure vehicle 6 and the ATM 1. The status of the ATM 1 may change during replenishment and so although an initial cash cassette may have been successfully loaded, it may not be possible to load further cassettes. For example, the ATM 1 may have been damaged during loading of a cash cassette, or an unrelated fault may have developed. The processing system 9 monitors the status of the ATM 1 throughout replenishment and should the status change, such that further replenishment is not possible, further cash cassettes will not be released by the transfer device 7.

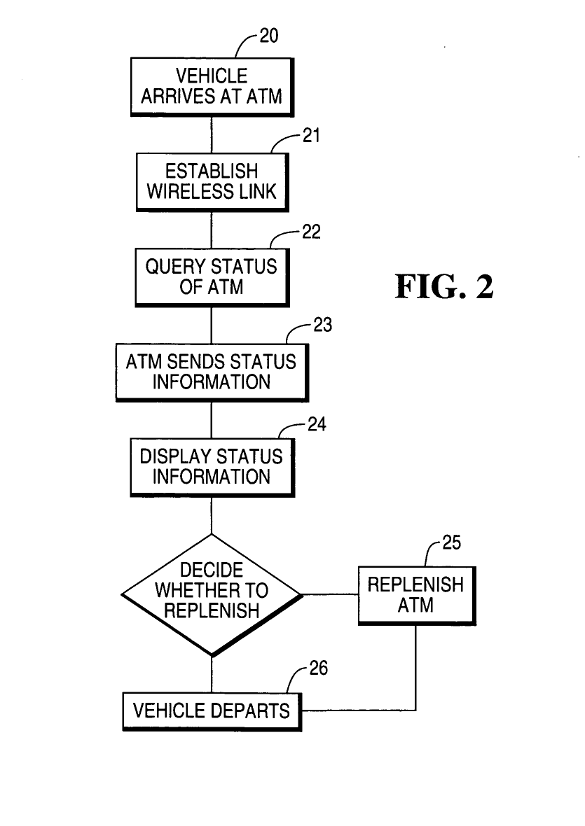

FIG. 2 shows flow chart of a method of replenishing an ATM. At step 20 a secure vehicle arrives in proximity to an ATM, and a wireless link is established 21 between the secure vehicle and the ATM. The status of the ATM is queried 22 by a processing system of the secure vehicle via the wireless link and the ATM sends 23 that status information to the secure vehicle. The status information is interpreted by the processing system and the relevant information displayed 24 to security personnel in the vehicle. If the status information indicates that the ATM can accept replenishment security personnel proceed with the replenishment 25. If, however, the status indicates that the ATM cannot accept replenishment, the security personnel do not leave the vehicle. Once replenishment has been completed, or it is decided not to replenish the ATM, the vehicle departs 26 from the ATM. The wireless link is cancelled upon departure from the ATM, or prior to departure should that be preferable.

During the step of replenishing 25 the ATM, the transfer device of the secure vehicle may be controlled on the basis of information received via the wireless communications link. For example, cash cassettes may only be transferred out of the vehicle when the ATM has indicated, via the wireless link, that it is ready to accept a cash cassette. The transfer device may be operated manually by security personnel within, or outside of, the secure vehicle, or it may be controlled by the processing system. Furthermore, a combination of automatic and manual control may be utilized.

During replenishment of an ATM it may also be necessary to transfer cash cassettes from an ATM to the secure vehicle. When that is required the secure vehicle indicates to the ATM, via the wireless link, that it is in a state to receive a cash cassette. The ATM will then release the cassette to security personnel for transfer to the vehicle. If the vehicle has not indicated that it can accept a cash cassette, the ATM will not release the cassette to the security personnel. Cash cassettes are therefore only released from an ATM when they can be transferred into a secure vehicle and the exposure of cash cassettes to potential theft is therefore reduced. The control of the release of cash cassettes from an ATM may be performed by controlling access to the ATM by controlling the lock of the ATM, or the release of cash cassettes from the pick units may be controlled.

The wireless communications link between the secure vehicle and the ATM may be utilized to transfer information about the replenishment process. For example, as a cash cassette is released by the van, the details of that cassette may be sent to the ATM. The ATM thus knows that a cash cassette is expected shortly, and the details of the cash cassette. The expectation of a cash cassette may be utilized to prepare security measures for the arrival of the cassette, for example the deactivation of certain alarms. Furthermore, the information may be used to update the ATMs internal records with respect to the cash cassettes currently within the ATM.

The foregoing description has been in relation to the replenishment of ATMs, but it will be apparent to the skilled reader that the systems and methods described herein, with appropriate and obvious modifications, are also suitable for use during the collection of cash from an ATM, or during other processes requiring the transfer of cash cassettes between an ATM a secure vehicle.

As described previously, ATMs store detailed logs of their performance and behavior over time. However, due to network bandwidth limitations, only some information from those logs can be transmitted over the standard ATM communications network. In order for the detailed logs to be examined it is therefore necessary for a technician to visit the ATM to extract the data. That requirement can lead to a significant delay in the repair of an ATM.

The system described hereinbefore, with reference to FIG. 1, allows the establishment of a wireless communications link between an ATM 1 and a secure vehicle 2 when the secure vehicle visits an ATM 1 to replenish it. That wireless communications link may be utilized to transmit information from the ATM's 1 logs to the processing system 9 of the secure vehicle 6. For example, when the status of the ATM 1 is queried by the secure vehicle 6 in order to determine whether to proceed with replenishment, the ATM 1 may indicate that it has information in its logs which should be transferred to the secure vehicle. Such an indication may be given due to a fault having occurred in the ATM 1, or if the transfer of routine operating details is required. Such a transfer of routine information may occur following a defined schedule, or may be triggered by certain events, and may be utilized to reduce the load on the normal ATM communications network. If the transfer is being made due to the occurrence of a fault, the information may contain details of the nature of the fault.

The information transmitted from the ATM 1 to the secure vehicle 6 can be examined by personnel in the secure vehicle 6, transmitted on to a central system for attention by other personnel, or stored on a storage system 11 in the secure vehicle 6 for later transmission or transport to relevant personnel. The storage system 11 in the secure vehicle may be of the removable type to allow the physical transport of the information to the requisite personnel. Such a method may be advantageous as transferred logs may occupy large amounts of storage space and transmission by other methods may be time consuming.

The wireless communications link between the secure vehicle 6 and the ATM 1 is a short-range link, and therefore can be a relatively high-capacity link, without employing expensive and complex radio systems. Furthermore, since only one ATM will use the link at a given time, and it is possible for the secure vehicle to remain close to the ATM for a moderate period of time, a lower capacity link may also be suitable. Such wireless links are well-known in the art and it will be clear to the person skilled in the art how a suitable wireless link may be implemented.

The transfer of logs from ATMs via the secure vehicle enables access to the logs by technicians without visiting the ATM itself, and without adding significant load to the standard ATM communications network. Since that standard network must handle all ATMs, any increase in the data transmitted from each ATM makes a very large difference to the total data that must be handled by that network. As has been explained, secure vehicles must visit each ATM on a regular basis for other purposes and so the transfer of information utilizing secure vehicles does not add significant time or expense to the process of managing ATMs.

The transfer of the information via the secure vehicle may enable a technician to investigate a particular fault, and to obtain the requisite spare parts, without visiting the faulty ATM, thereby saving time and expense associated with repeated visits to an ATM.

Any range or device value given herein may be extended or altered without losing the effect sought, as will be apparent to the skilled person.

The steps of the methods described herein may be carried out in any suitable order, or simultaneously where appropriate.

It will be understood that the above description of a preferred embodiment is given by way of example only and that various modifications may be made by those skilled in the art.

The phrase “processing system” is used to refer to any electronic, or similar, system capable of processing data. For example, the processing system may be a computer system or a microprocessor, as is well known in the art.

In foregoing description and figures the wireless communications device and processing system have been described as separate units. As will be understood by the person skilled in the art, a single device may provide the functionality of both the wireless communications device and the processing system.

The above description has referred to the delivery of bank notes to ATMs, but as will be apparent to the person skilled in the art, the description is also relevant to the delivery of any valuable items to a particular location, including, but not limited to, other types of self-service terminals dispensing items other than money to customers.

Reference has been made in the foregoing description to the inability to replenish an ATM due to a fault condition in that ATM. As will be understood by the person skilled in the art, there may be other reasons that mean replenishment of an ATM should not be performed. Those reasons may also be communicated to the secure vehicle such that security personnel do not attempt replenishment. For example, usage of a given ATM may have been lower than normal and therefore the ATM will still have a sufficient stock of money when it is time for scheduled replenishment. In that case the status information communicated to the secure vehicle will indicate that replenishment should not be carried out as it is not required.

As will be apparent to the person skilled in the art, features of the apparatus and methods described herein are interchangeable. Accordingly features of the apparatus and system described previously may be utilized in the method, and features of the method may be incorporated into the features provided by the system and apparatus.

What is claimed is:

1. A method of replenishing a Self-Service Terminal (SST), comprising the steps of:
establishing a wireless communications link between an SST and a vehicle,
the vehicle receiving status information with regard to the state of the SST via the wireless communications link, and
performing an action dependent upon the status information received by the vehicle.

2. A method of replenishing a Self-Service Terminal (SST) as claimed in claim 1 further comprising the step of displaying information with regard to the state of the SST in the vehicle.

3. A method of replenishing a Self-Service Terminal (SST) as claimed in claim 1 wherein the action performed is the provision of an indication to security personnel to proceed with replenishment of the SST.

4. A method of replenishing a Self-Service Terminal (SST) as claimed in claim 1 wherein the action performed is the provision of an indication to security personnel not to proceed with replenishment of the SST.

5. A method of replenishing a Self-Service Terminal (SST) as claimed in claim 1 further comprising the step of controlling the transfer of an item out of the secure vehicle dependent upon the status information received by the vehicle.

6. A method of replenishing a Self-Service Terminal (SST) as claimed in claim 1, further comprising the step of the vehicle receiving and storing status information from the SST.

7. A Self-Service Terminal (SST) management system, comprising:
a mobile wireless communications device, configured to establish a wireless communications link with an SST which is temporarily within range of that mobile wireless communications device, and
a processing system connected to the mobile wireless communications device, such that the processing system can communicate with the SST via the wireless communications link, wherein
the processing system is configured to receive status information from the SST via the wireless communications link which is indicative of the ability of the SST to function at that time.

8. A Self-Service Terminal (SST) management system as claimed in claim 7 wherein the mobile wireless communications device and processing system are located in a secure vehicle.

9. A Self-Service Terminal (SST) management system as claimed in claim 8 wherein the secure vehicle further comprises a transfer device for transferring items into and out of the secure vehicle.

10. A Self-Service Terminal (SST) management system as claimed in claim 9 wherein the transfer device is configured to be controlled dependent upon status information received from the SST.

11. A Self-Service Terminal (SST) management system as claimed in claim 8 wherein the secure vehicle further comprises a display device for displaying status information received from the SST.

12. A Self-Service Terminal (SST) management system as claimed in claim 7 further comprising a removable data storage device connected to the processing system and configured to store information received via the wireless communications link from the SST.

13. A Self-Service Terminal (SST) management system as claimed in claim 7 further comprising a fixed wireless communications device for connection to an SST.

14. A Self-Service Terminal (SST) management system as claimed in claim 13 wherein the fixed wireless communications device is configured to transmit status information to a mobile wireless communications device temporarily brought within range of the fixed wireless communications device.

15. A Self-Service Terminal (SST), comprising:
a fixed wireless communications device, configured to establish a wireless communications link with a mobile wireless communications device temporarily brought within the range of the fixed wireless communications device, and
a processing system connected to the fixed wireless communications device, the processing system being configured to transmit status information via the wireless communications link.

16. A Self-Service Terminal (SST) as claimed in claim 15 wherein the fixed wireless communications device is configured to transmit logs of status information from the SST to the mobile wireless communications device via the wireless communications link.
